(19) United States
(12) Patent Application Publication
(10) Pub. No.: US 2026/0301604 A1
(43) Pub. Date: Oct. 1, 2026

(54) ANTHROPOMORPHIC TEST DEVICES HAVING DEFORMABLE SENSORS

(71) Applicant: Toyota Research Institute, Inc., Los Altos, CA (US)

(72) Inventor: Patrick Miller, Oakland, CA (US)

(73) Assignees: Toyota Research Institute, Inc., Los Altos, CA (US); Toyota Jidosha Kabushiki Kaisha, Toyota-shi (JP)

(21) Appl. No.: 19/093,519

(22) Filed: Mar. 28, 2025

(51) Int. Cl. G09B 23/30; G01B 11/16

(52) U.S. Cl. CPC G09B 23/30; G01B 11/16

(57) ABSTRACT

In one embodiment, an anthropomorphic test device for testing a vehicle at least one body section. Each body section includes a body and an array of deformable sensors coupled to the body. Each deformable sensor includes a deformable membrane defining an enclosure, where the enclosure is filled with a medium, and an internal sensor positioned within the enclosure. The anthropomorphic test device also includes a skin layer disposed on the array of deformable sensors.

### BACKGROUND

Anthropomorphic test devices, colloquially referred to a “crash test dummies,” are devices used to evaluate how the human body responds during a crash test of a vehicle. Many anthropomorphic test devices have a rigid body, and thus do not correspond to the soft and deformable skin of a human being. This may cause incorrect sensor data to be recorded during a crash test. Additionally, existing anthropomorphic test devices cannot directly record impact forces on the skin of a human.

Accordingly, alternative anthropomorphic test devices may be desired.

### BRIEF SUMMARY

In one embodiment, an anthropomorphic test device for testing a vehicle at least one body section. Each body section includes a body and an array of deformable sensors coupled to the body. Each deformable sensor includes a deformable membrane defining an enclosure, where the enclosure is filled with a medium, and an internal sensor positioned within the enclosure. The anthropomorphic test device also includes a skin layer disposed on the array of deformable sensors.

In another embodiment, an anthropomorphic test device for testing a vehicle at least one body section having a body, a skin layer offset from the body, where an enclosure is defined between the skin layer and the body and the enclosure is filled with a medium, and an array of internal sensors positioned on the body and within the enclosure, where the array of internal sensors have a field of view of an underside of the skin layer.

In another embodiment, a skin sensor for coupling to a body section of an anthropomorphic test device includes a base layer. The skin sensor also includes an array of deformable sensors coupled to the base layer. Each deformable sensor includes a deformable membrane defining an enclosure with respect to the base layer, where the enclosure is filled with a medium, and an internal sensor positioned within the enclosure. The skin sensor also includes a skin layer disposed on the array of deformable sensors.

These and additional features provided by the embodiments described herein will be more fully understood in view of the following detailed description, in conjunction with the drawings.

### BRIEF DESCRIPTION OF THE SEVERAL VIEWS OF THE DRAWINGS

FIG. 1 illustrates an example anthropomorphic test device according to one or more embodiments described and illustrated herein.

FIG. 2 illustrates an example body section of an anthropomorphic test device according to one or more embodiments described and illustrated herein.

FIG. 3 illustrates cross-sectional view of an example anthropomorphic test device having a plurality of deformable sensors according to one or more embodiments described and illustrated herein.

FIG. 4 illustrates an example deformable sensor according to one or more embodiments described and illustrated herein.

FIG. 5 illustrates a perspective view of the example deformable sensor of FIG. 3 according to one or more embodiments described and illustrated herein.

FIG. 6 illustrates a cross-sectional view of another anthropomorphic test device according to one or more embodiments described and illustrated herein.

FIG. 7 illustrates an underside of an example skin layer having a plurality of patterns according to one or more embodiments described and illustrated herein.

### DETAILED DESCRIPTION

Embodiments of the present disclosure are directed to anthropomorphic test devices for evaluating vehicles during crash test scenarios that have a soft and compliant skin, much like human skin. The outer skin layer of the anthropomorphic test devices include deformable sensors that are capable of detect both a force of an object, as well as the pose of the object (i.e., the direction of force of an object on the anthropomorphic test device during a crash test). The sensorized skin layer provides additional data for vehicle designers to review following crash tests. In some embodiments, a skin sensor including a base body, deformable sensors, and a skin layer is applied to an existing anthropomorphic test device to improve the capabilities of the existing anthropomorphic test device.

Various embodiments of anthropomorphic test devices and skin sensors are described below.

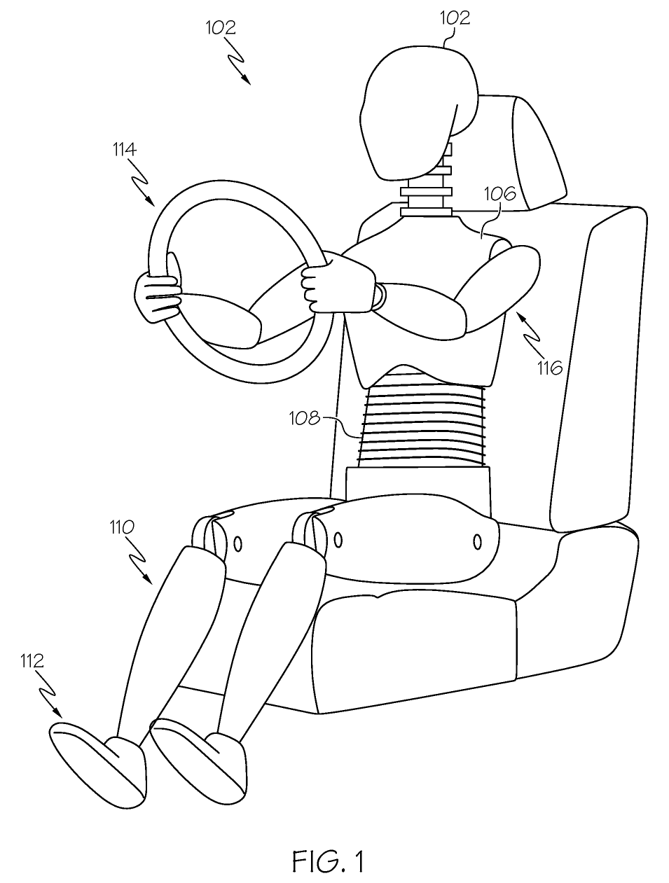

Referring now to FIG. 1, an example anthropomorphic test device 102 is illustrated as operating a vehicle and grasping a steering wheel 114. The anthropomorphic test device 102 may be used to evaluate the effects of a vehicle crash during a crash test. The anthropomorphic test device 102 generates data as to how the human body responds during certain crash scenarios. The anthropomorphic test device 102 is shaped and configured as a human body, and may be designed to reflect many different body shapes, sizes and ages. As shown in FIG. 1, the example anthropomorphic test device 102 has a head 104, an upper body 106, arms 116, a torso 108, legs 110 and feet 112.

The anthropomorphic test device 102 is sensorized to generate data regarding crash impacts on the human body. The anthropomorphic test device 102 generates data at various parts of the body, such as the head 104, upper body 106, arms 116, torso 108, legs 110, and/or feet 112. In this manner, changes in vehicle design may be made (e.g., placement or design of airbags, crumple zone modifications) to improve performance during subsequent tests.

The anthropomorphic test devices 102 of the present disclosure has a soft skin layer 132 that mimics human skin. It is deforms when it receives an external force, much like human skin. The skin layer 132 improves data generated during the crash test because the anthropomorphic test device 102 is not hard and rigid. Therefore, the anthropomorphic test device 102 responds in a more human-like manner than traditional anthropomorphic test devices.

The anthropomorphic test devices 102 devices include internal sensors (not shown) that generate crash test data. For example, the internal sensors may be inertial measurement unit sensors, such as, without limitation, accelerometers and gyroscopes. Any other internal sensors may also be utilized.

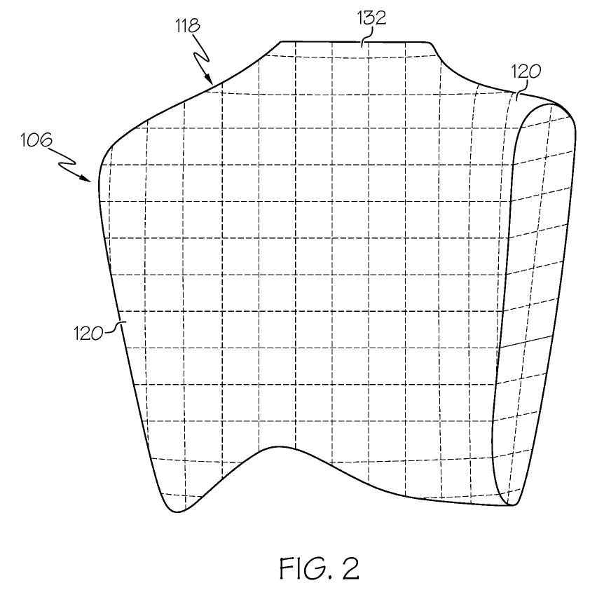

The skin layer 132 of one or more body sections may also be sensorized to generate data regarding a crash test. Referring now to FIG. 2, the upper body 106 (e.g., the chest and back) is sensorized and includes an array of sensing zones 118. Each sensing zone 120 of the array of sensing zones 118 is operable to detect a force applied the skin layer 132 at the particular sensing zone 120. More particularly, each sensing zone 120 detects a location and magnitude of deformation of the skin layer. In this manner, the anthropomorphic test device 102 generates precise impact data at various locations around the body. This impact data is very helpful for vehicle designers when designing and refining vehicle designs and features. For example, significant forces may be measured by sensing zones 120 near the left shoulder. Adjustments to seat position, airbag design, and other design considerations may be made to address the significant forces at the left shoulder to improve the design of the vehicle.

The area of each sensing zone 120 is not limited by this disclosure. Additionally, although the size of each sensing zone 120 is equal in FIG. 2, in some embodiments the size of the sensing zones 120 may vary across the array of sensing zones 118. As a non-limiting example, the sensing zones 120 near the bottom of the upper body 106 may be larger than those near the top to provide more sensing zones 120 where an impact may be felt.

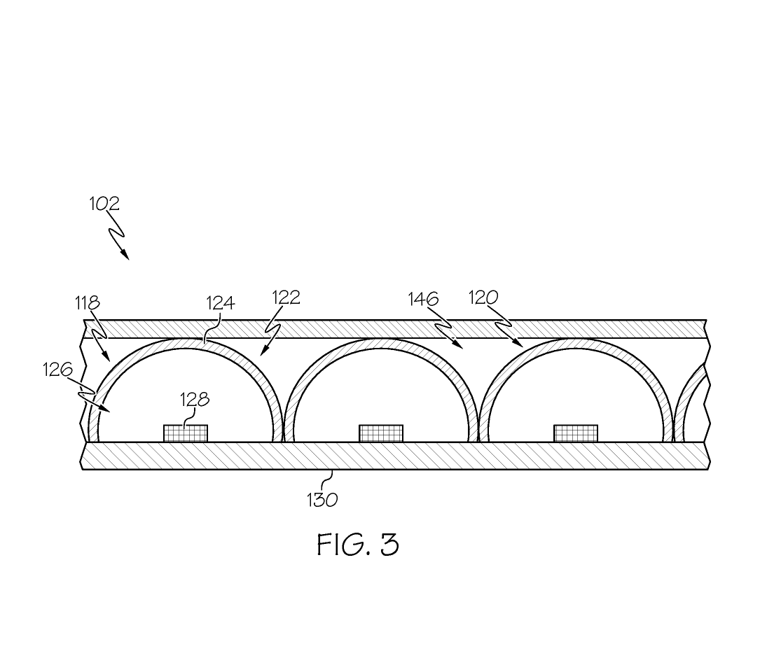

Referring now to FIG. 3, a cross-section of a portion of an example anthropomorphic test device 102 illustrating three sensing zones 120 is shown. Each sensing zone 120 includes a deformable membrane 124 that is coupled to a body 130. The body 130 may be a rigid surface of the anthropomorphic test device 102 as a non-limiting example. In some embodiments, the body 130 is a base layer that is later applied to a surface of the anthropomorphic test device 102. In such embodiments, the body 130, plurality of deformable sensors 122, and the skin layer 132 define a skin sensor that can be applied to an existing anthropomorphic test device (e.g., using an adhesive). In this manner, existing anthropomorphic test devices can be equipped with skin sensing capabilities.

The deformable membrane 124 may be attached to the body 130 by any appropriate means, such as adhesive, bonding, and clamps. In one embodiment, the deformable membrane 124 is attached to the body 130 by a heat seal. For example, a deformable membrane sheet may be heat sealed to the body 130 to define an array of sensing zones 118.

For each deformable sensor 122, the deformable membrane 124 defines an enclosure 126 that is filled with a medium. The medium may be a gas, such as air, a liquid, or a semi-solid, such as a gel. An internal sensor 128 is disposed within the enclosure 126. The internal sensor 128 has a field of view of an underside of the deformable membrane 124. As described in more detail below, the internal sensor 128 may be a depth sensor, such as a time-of-flight sensor, that detects a magnitude and a location of deformation of the deformable membrane 124. The medium within the enclosure 126 causes the deformable sensor 122 to form a shape, such as a dome shape.

A deformable skin layer 132 is provided on top of the array of sensing zones 118. The deformable membrane 124 of the array of sensing zones 118 and the skin layer 132 create a plurality of interstitial spaces 146. In some embodiments, the enclosures 126 are filled with a gel and the interstitial spaces 146 are filled with air. The skin layer 132 is made of a deformable material that mimics human skin. Non-limiting example materials for the skin layer 132 are latex, elastomers, epoxy resins, and liquid suspension materials.

When force is applied to the skin layer 132, the skin layer 132 deforms, which also causes one or more of the deformable membranes 124 of one or more deformable sensors 122 to deform closer to the corresponding internal sensors 128. The internal sensors 128 detect the deformation of the deformable membranes 124 and produce data that is then provided to a data recording device such as a computer, for example. Additional detail regarding the deformable sensor 122 is described below and illustrated in FIGS.

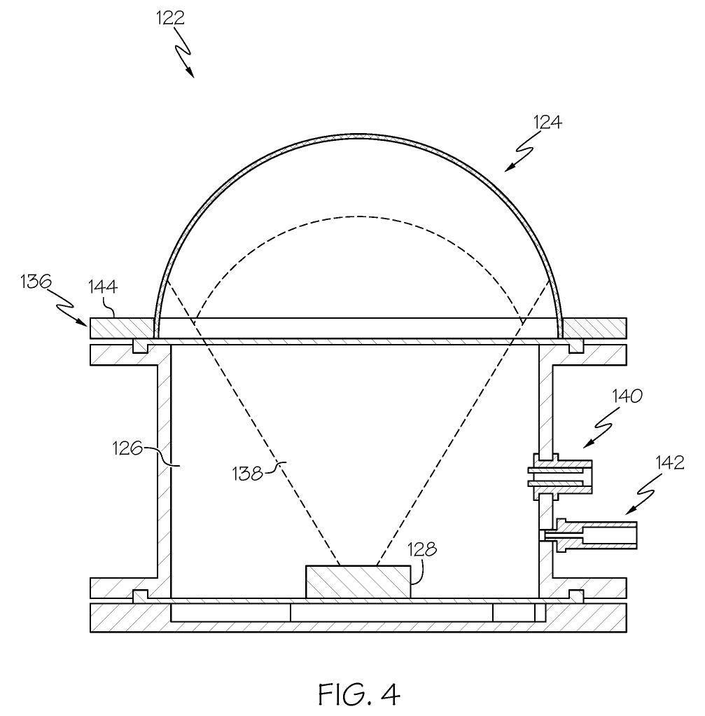

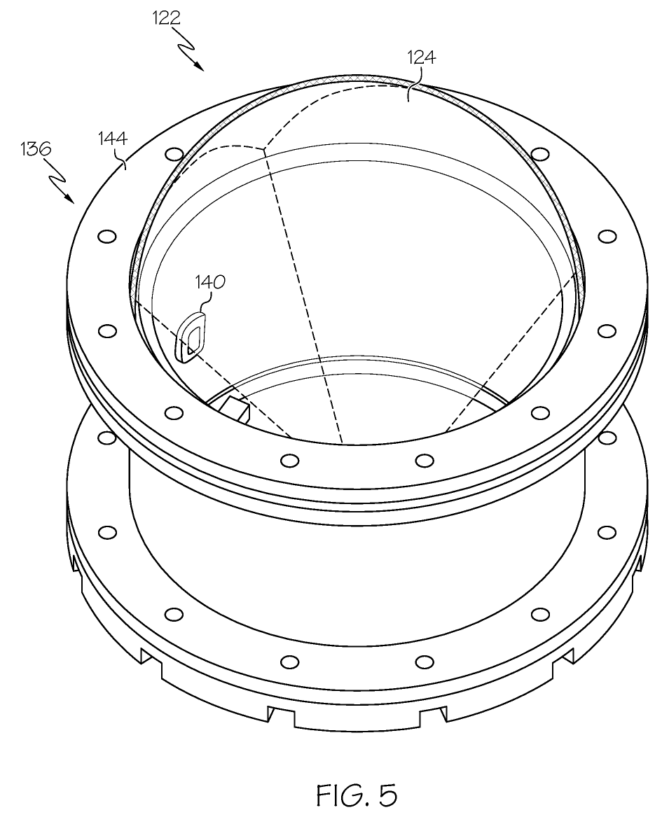

Referring now to FIGS. 4 and 5, an example deformable sensor 122 that may be included in the anthropomorphic test device 102 is schematically illustrated. FIG. 4 is a front elevation view of the example deformable sensor 122 and FIG. 5 is a top perspective view of the example deformable sensor 122. The example deformable sensor 122 generally comprises a housing 136 and a deformable membrane 124 coupled to the housing 136, such as by an upper portion 144 of the housing 136. In some embodiments, the housing 136 is embedded into the outer surface of the anthropomorphic test device 102 (e.g., the body 130). In other embodiments, the deformable membrane 124 is attached directly to the body of the anthropomorphic test device 102 (e.g., by heat sealing).

The housing 136 and the deformable membrane 124 define an enclosure 126 that is filled with a medium through one or more passthroughs 140, which may be a valve or any other suitable mechanism. The passthrough 140 may be utilized to fill or empty the enclosure. In one example, the medium is gas, such as air. Thus, air may be pumped into the enclosure 126 to a desired pressure such that the deformable membrane 124 forms a dome shape as shown in FIG. 4.

The deformability of the deformable sensor 122 may be tuned/modified by changing the material of the deformable membrane 124 and/or the pressure within the enclosure 126. By using a softer material (e.g., soft silicone), the deformable sensor 122 may be more easily deformed. Similarly, lowering the pressure within the enclosure 126 may also cause the deformable membrane 124 to more easily deform, which may in turn provide for a more deformable sensor 122. In some embodiments robots feature varying touch sensitivity due to varying spatial resolution and/or depth resolution.

An internal sensor 128 capable of sensing depth may be disposed within the enclosure 126, which may be measured by the depth resolution of the internal sensor 128. The internal sensor 128 may have a field of view 138 directed through the medium and toward a bottom surface of the deformable membrane 124. In some embodiments the internal sensor 128 may be an optical sensor. As described in more detail below, the internal sensor 128 may be capable of detecting deflections of the deformable membrane 124 when the deformable membrane 124 comes into contact with an object. In one example, the internal sensor 128 is a time-of-flight sensor capable of measuring depth. The time-of-flight sensor emits an optical signal (e.g., an infrared signal) and has individual detectors (i.e., “pixels”) that detect how long it takes for the reflected signal to return to the sensor. The time-of-flight sensor may have any desired spatial resolution. The greater the number of pixels, the greater the spatial resolution. The spatial resolution of the sensor disposed within the internal sensor 128 may be changed. In some cases, low spatial resolution (e.g., one “pixel” that detects a single point’s displacement) may be desired. In others, a sensitive time-of-flight sensor such may be used as a high spatial resolution internal sensor 128 that provides dense tactile sensing. Thus, the internal sensor 128 may be modular because the sensors may be changed depending on the application. Other types of visual internal sensors include, by way of non-limiting example, stereo cameras, laser range sensors, structured light sensors/3d scanners, single cameras (such as with dots or other patterns inside), or any other suitable type of visual detector. For example, the internal sensor 128 may be configured as a stereo-camera capable of detecting deflections of the deformable membrane 124 by an object.

Any suitable quantity and/or types of internal sensors 128 may be utilized within a single deformable sensor 122 in some embodiments. In some examples, not all internal sensors 128 within a deformable sensor 122 need be of the same type. In various embodiments, one deformable sensor 122 may utilize a single internal sensor 128 with a high spatial resolution, whereas another deformable sensor 122 may use a plurality of internal sensors 128 that each have a low spatial resolution. In some embodiments the spatial resolution of a deformable sensor 122 may be increased due to an increase in the quantity of internal sensors 128. In some examples, a decrease in the number of internal sensors 128 within a deformable sensor 122 can be compensated for by a corresponding increase in the spatial resolution of at least some of the remaining internal sensors 128. As discussed in more detail below, the aggregate deformation resolution may be measured as a function of the deformation resolution or depth resolution among the deformable sensors 122 in a portion of an anthropomorphic test device 102. In some embodiments aggregate deformation resolution may be based upon a quantity of deformable sensors in a portion of the robot and a deformation resolution obtained from each deformable sensor in that portion.

Referring again to FIG. 4, a conduit 142 may be utilized in the enclosure 126 to provide power and/or data/signals, such as to the internal sensor 128 by way of a conduit, such as for USB (universal serial bus) or any other suitable type of power and/or signal/data connection. As used herein, an airtight conduit may include any type of passageway through which air or any other fluid (such as liquid) cannot pass. In this example, an airtight conduit may provide a passageway through which solid object (such as wires/cables) may pass through by with an airtight seal being formed around such wires/cables at each end of the airtight conduit. Other embodiments utilized wireless internal sensors 128 to transmit and/or receive data and/or power. In various embodiments where the medium is not a gas, such as silicone, the enclosure 126 and/or conduit 142 may not necessarily be airtight.

In some embodiments the internal sensor 128 may include one or more internal pressure sensors (barometers, pressure sensors, etc., or any combination thereof) utilized to detect the general deformation of the deformable membrane 124 through the medium. In some embodiments the deformable sensor 122 and/or internal sensor 128 may receive/send various data, such as through the conduit 142 discussed above, wireless data transmission (wi-fi, Bluetooth, etc.), or any other suitable data communication protocol. For example, pressure within a deformable sensor 122 may be specified by a pressurization parameter and may be inversely proportional to the deformability of the deformable sensor 122. In some embodiments the deformability of a deformable sensor 122 may be modified by changing pressure within the enclosure 126 or a material of the deformable membrane 124. In some embodiments receipt of an updated parameter value may result in a real-time or delayed update (pressurization, etc.).

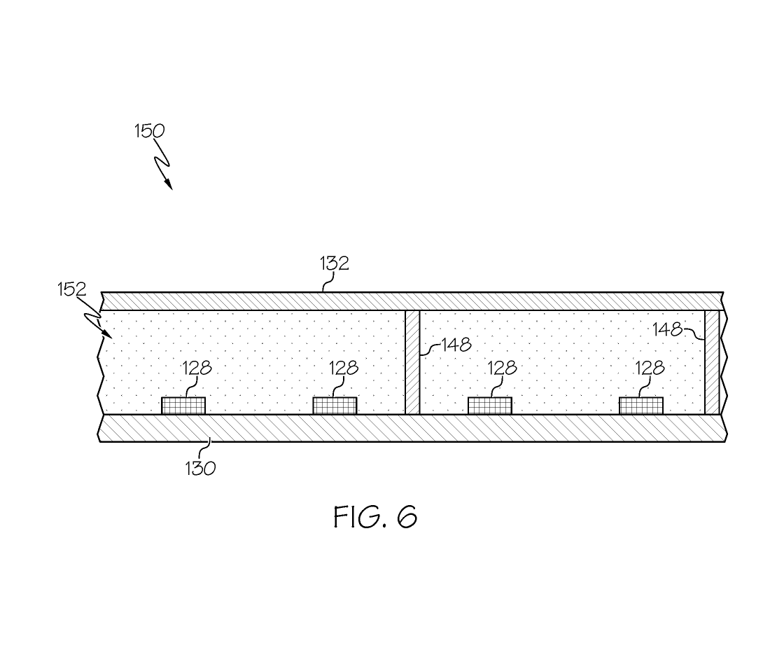

Referring now to FIG. 6, a cross-sectional view of another embodiment of an anthropomorphic test device 150 is illustrated. The skin layer 132 is offset from the body 130. In the illustrated embodiment, the skin layer 132 acts as the deformable membranes 124 of the embodiment shown in FIG. 3. Thus, there are no deformable membranes 124 between the skin layer 132 and the body 130. Rather, the space 152 between the body 130 and the skin layer 132 is filled with a medium, such as a gel. The space 152 provides an area for the skin layer 132 to deform in a direction toward an array of internal sensors 128. The array of internal sensors 128 define an array of sensing zones 118 such as shown in FIG. 2, for example. The internal sensors 128 may be configured similarly to those described above with respect to FIG. 4, and may be depth sensors, such as time-of-flight sensors, and camera sensors. The array of internal sensors 128 are operable to detect a force and a pose of an object applied to the skin layer 132.

In some embodiments, the anthropomorphic test device 150 includes an array of deformable pillars 148 that are operable to maintain the skin layer 132 in a position that is offset from the body 130. The deformable pillars 148 are made of a material such that they deform when in contact with a force. It should be understood that in other embodiments the deformable pillars 148 are not used.

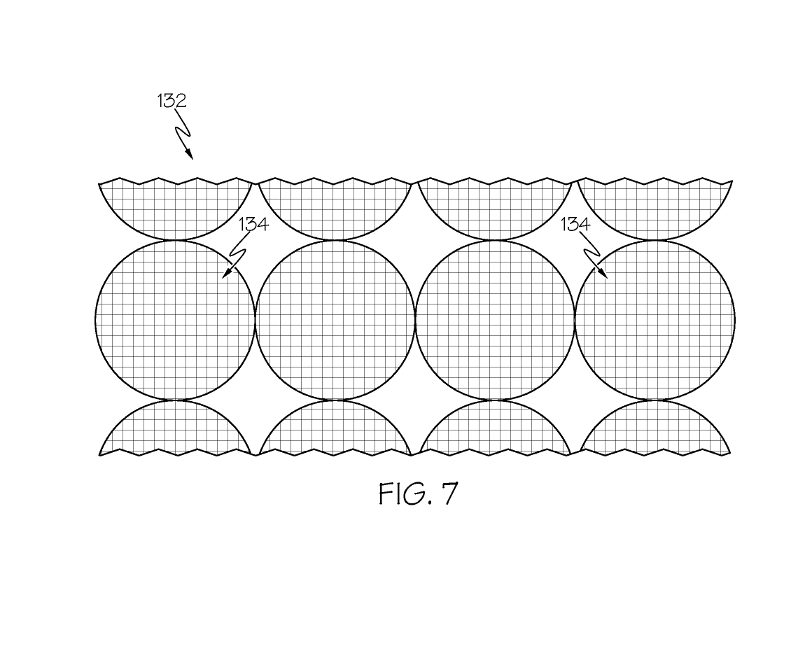

Referring now to FIG. 7, the underside of the skin layer 132 of FIG. 6 may include one or more patterns 134 that are visible to the array of internal sensors 128. As shown in FIG. 7, each pattern 134 may correspond to a single sensing zone as shown in FIG. 2. In other embodiments, the entire underside of the skin layer 132 may have one pattern without the defined array of patterns shown in FIG. 7. The patterns 134 may be grid patterns applied to a underside of the deformable membrane 124 to assist in the detection of the deformation of the deformable membrane 124. For example, the patterns 134 may assist in the detection of the deformation when the internal sensors 128 are a stereo-cameras. For example, varying degrees of distortion to the patterns 134 may be utilized to discern how much deformation has occurred. In this example, the distance between parallel lines and/or measuring curvature of lines in the grid patterns 134 may be used to determine the amount of deformation at each point in the grid. It should be understood that embodiments are not limited to grid patterns, as other types of patterns are possible, such as dots, shapes, and the like. The patterns 134 on the skin layer 132 may be random, and not necessarily arranged in a grid pattern or an array as shown in FIG. 7.

It should now be understood that embodiments of the present disclosure are directed anthropomorphic test devices having deformable sensors capable of detecting contact with one or more objects, as well as a geometric shape and pose of an object, during crash test scenarios. The deformable sensors on the anthropomorphic test device provide high-resolution sensor data all over the body of the anthropomorphic test device, providing improved data collection during crash tests. Additionally, the deformable sensors described herein form a human-like skin on the anthropomorphic test device, which provides more realistic and accurate test results.

It is noted that the terms "substantially" and "about" and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An anthropomorphic test device for testing a vehicle, the anthropomorphic test device comprising:
at least one body section comprising:
a body;
an array of deformable sensors coupled to the body, each deformable sensor comprising:
a deformable membrane defining an enclosure, wherein the enclosure is filled with a medium; and
an internal sensor positioned within the enclosure; and
a skin layer disposed on the array of deformable sensors.

2. The anthropomorphic test device of claim 1, the at least one body section comprises a plurality of body sections.

3. The anthropomorphic test device of claim 1, wherein the array of deformable sensors and the skin layer define a plurality of interstitial spaces.

4. The anthropomorphic test device of claim 3, wherein the medium within the enclosure of each deformable sensor is a gel, and the interstitial spaces are filled with gas.

5. The anthropomorphic test device of claim 1, wherein each deformable sensor further comprises a housing and the deformable membrane is coupled to the housing.

6. The anthropomorphic test device of claim 1, wherein the internal sensor comprises a depth sensor.

7. The anthropomorphic test device of claim 6, wherein the depth sensor comprises a time-of-flight sensor.

8. The anthropomorphic test device of claim 1, wherein an underside of the deformable membrane of each deformable sensor comprises a pattern.

9. The anthropomorphic test device of claim 1, wherein the skin layer comprises latex.

10. The anthropomorphic test device of claim 1, wherein the deformable membrane is attached to the body by a heat-seal.

11. An anthropomorphic test device for testing a vehicle, the anthropomorphic test device comprising:
at least one body section comprising:
a body;
a skin layer offset from the body, wherein an enclosure is defined between the skin layer and the body and the enclosure is filled with a medium; and
an array of internal sensors positioned on the body and within the enclosure, wherein the array of internal sensors have a field of view of an underside of the skin layer.

12. The anthropomorphic test device of claim 11, the at least one body section comprises a plurality of body sections.

13. The anthropomorphic test device of claim 11, wherein the medium is a gel.

14. The anthropomorphic test device of claim 11, wherein the internal sensor comprises a depth sensor.

15. The anthropomorphic test device of claim 14, wherein the depth sensor comprises a time-of-flight sensor.

16. The anthropomorphic test device of claim 14, wherein the underside of the skin comprises at least one pattern.

17. The anthropomorphic test device of claim 16, wherein the at least one pattern comprises a plurality of patterns, with each individual pattern of the plurality of patterns corresponding with an individual internal sensor of the array of internal sensors.

18. The anthropomorphic test device of claim 16, wherein the skin layer comprises latex.

19. The anthropomorphic test device of claim 16, further comprising an array of deformable pillars, wherein the array of deformable pillars are configured to maintain the skin layer offset from the body.

20. A skin sensor for coupling to a body section of an anthropomorphic test device, the skin sensor comprising:
a base layer;
an array of deformable sensors coupled to the base layer, each deformable sensor comprising:
a deformable membrane defining an enclosure with respect to the base layer, wherein the enclosure is filled with a medium; and
an internal sensor positioned within the enclosure; and
a skin layer disposed on the array of deformable sensors.
